(19) United States
(12) Patent Application Publication
(10) Pub. No.: US 2009/0257005 A1
(43) Pub. Date: Oct. 15, 2009

(54) Liquid Crystal Display Device

(76) Inventors: Hiroyuki Kamee, Nara (JP); Yozo Narutaki, Nara (JP); Kazuhiko Tsuda, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/083,477

(22) PCT Filed: Sep. 20, 2006
(86) PCT No.: PCT/JP2006/318611

§ 371 Date: Apr. 14, 2008

(30) Foreign Application Priority Data
Oct. 18, 2005 (JP) 2005-303698

(51) Int. Cl. G02F 1/1335

(52) U.S. Cl. 349/98

(57) ABSTRACT

The inventive liquid crystal device is driven in circular polarization mode. A protection plate (22) is provided with a first optical member where a first polarizing plate (23) and a first wave plate (24) are laid in layers sequentially in the order of the first phase difference plate and the first polarizing plate from the side close to a liquid crystal display panel. Optical conditions of the first optical member are designed such that the incident light from the observer side becomes elliptically polarized light having an ellipticity of 0.4-1.0 when it passed through the protection plate and the first optical member and the elliptically polarized light impinges on the liquid crystal layer. Consequently, surface reflection on each substrate and film in the liquid crystal display can be reduced effectively.

### TECHNICAL FIELD

The present invention relates to a liquid crystal display device for use in a device such as a mobile device, the liquid crystal display including a protection plate for protecting damages externally applied to a display.

### BACKGROUND ART

A liquid crystal display device is generally characterized by lightweight, flat shape, low voltage operation, low power consumption, and the like, and currently used as a display section of various equipments.

The liquid crystal display device definitely requires a light source, and at the present time, is categorized into the following three types in the marketplace: a transmissive liquid crystal display device, which has a light-emitting light source such as a cold cathode tube, an LED on a back surface of a liquid crystal display panel; a reflective liquid crystal display device, which utilizes surrounding light such as sunlight for providing a display; and a transflective liquid crystal display device, which utilizes both light sources of the light-emitting light source on the back surface and the surrounding light.

Especially, in a case where a liquid crystal display device is used for a mobile device, when it is used out of doors, strong external light causes undesired reflection from a surface of the liquid crystal display device or from a boundary face due to differences in refractivity in the liquid crystal display device. This causes improper display.

In viewpoint of an expected usage environment of the mobile device, it is also conceivable that visibility is impaired because the surface is scratched or a substrate is damaged as various external forces are applied to the liquid crystal display device. For this reason, as illustrated in FIG. 12, it is necessary to provide a protection plate 22 for protecting a liquid crystal display panel on an observer side via a space (a protection plate which is mainly used these days is, for example, a plate which is flat on both sides and made of a plastic material such as acrylic). In a case where such a protection plate 22 is provided, undesired reflection is also caused on the both sides of the protection plate.

These occurrences are illustrated in FIG. 13. An arrow a indicates undesired reflection from a front surface of the protection plate 22, an arrow b indicates undesired reflection from a back surface of the protection plate 22, an arrow c indicates undesired reflection from a front surface of a first substrate 31, an arrow d indicates undesired reflection from a front surface of a black matrix (BM), which is an example of reflection from a panel, and an arrow e indicates undesired reflection from a first ITO (indium tin oxide) film 34, which is another example of reflection from a panel.

In order to reduce these occurrences, technologies disclosed in Japanese Examined Utility Model Application Publication, Jitsukohei, No. 6-24812, Japanese Unexamined Patent Publication, Tokukaihei, No. 3-156420 are proposed.

FIG. 14 illustrates an arrangement disclosed in Japanese Examined Utility Model Application Publication, Jitsukohei, No. 6-24812. An antireflective plate 511 is provided on a side close to an observer side and a liquid crystal display panel 512 is provided on a far side via a space 505. The antireflective plate 511 includes, in the order of being close to the observer side, an antireflective film 501, a transparent protection plate 502, a linear polarizing plate 503, and a quarter wave plate 504. The liquid crystal display panel 512 includes, in the order of being close to the observer side, a quarter wave plate 506, a liquid crystal display element 507, and a linear polarizing plate 508. That is, the antireflective film 501 is provided on a front side (observer side) of the transparent protection plate 502, the linear polarizing plate 503 is provided on a back surface (liquid crystal element side) of the transparent protection plate 502. Furthermore, the quarter wave plate 506 is provided on a front surface of the liquid crystal display element 507. With the arrangement, the antireflective film 511 reduces reflection from the front surface (observer side) of the transparent protection plate 502. Circularly polarized light, which passed through the linear polarizing plate 503 and the quarter wave plate 504 on the back surface of the transparent protection plate 502, is reflected from the front surface of the liquid crystal display panel 512, and changes its direction. When the circularly polarized light passes the circularly polarized light plate again, a polarization axis rotates by 90°, thereby resulting in that the light is blocked off. In this way, the undesired reflection is reduced.

According to this proposal, as a liquid crystal display mode is operated in a TN mode, it is necessary that linear polarized light be incident on the liquid crystal display element. For this reason, another quarter wave plate is provided on the front surface of the liquid crystal display element.

However, the following problems arise.

(1) Undesired reflection from inside the liquid crystal display element is caused by reflection of light which becomes linear polarized light at the quarter wave plate provided on the front surface of the liquid crystal display element. This causes the reflected light to be parallel to a transmission axis of the linear polarizing plate, and passes through the linear polarizing plate. Therefore, with the arrangement, the undesired reflection occurred in the liquid crystal display element cannot be reduced.

(2) The provision of at least two more layers, in addition to the conventional arrangement, causes both the cost and the thickness of the device to increase.

FIG. 15 illustrates an arrangement disclosed in Japanese Unexamined Patent Publication, Tokukaihei, No. 3-156420. A protection plate 621 is provided on a side close to the observer side, and a liquid crystal display panel 622 is provided on a far side via a space 60505.

The protection plate 621 includes, in the order of being close to the observer side, a surface-reflection prevention film 601, a transparent plate 602, a polarizer 603, a quarter wave plate 604. The liquid crystal display panel 622 includes, in the order of being close to the observer side, a glass plate 606, a color filter 607, a light controller 608, a quarter wave plate 609, a transparent electrode 610, an alignment control film 611, a liquid crystal 612, an alignment control film 613, a pixel electrode 614, a glass plate 615, and a polarizer 616. Similarly to Japanese Examined Utility Model Application Publication, Jitsukohei, No. 6-24812, it is possible to reduce undesired reflection from a front surface and a back surface of the protection plate, and on a front surface of the liquid crystal display element.

Moreover, the quarter wave plate is provided on a side closer to the liquid crystal than the light controller (which works similarly to a later described black matrix), so that circularly polarized light is incident on the light controller. This allows reducing undesired reflection caused on the boundary face of the light controller.

However, the following problems arise.

(1) The provision of at least two more layers, in addition to the conventional arrangement, causes both the cost and the thickness of the device to increase.

(2) It is difficult to provide the quarter wave plate on the side closer to the liquid crystal than the glass plate (it is difficult to carry out flatness control, in-plane uniformity control of retardation, alignment control, transparency control or the like). In addition, the cost, incurred by the provision of the quarter wave plate, is increased.

(3) Undesired reflection from an ITO (a first ITO film 34) is caused by reflection from light which has been linearly polarized by the quarter wave plate. Therefore, with the arrangement, the undesired reflection cannot be reduced.

Generally, there are two types of materials which are used as a light controller, that is, a black matrix (BM). One is a resin material, and the other is a low reflective metal lamination in which a chrome metal is mainly used. A resin BM has refractivity substantially similar to a substrate, and absorbs visible light because the resin includes a black material such as ink or carbon black. Reflectance is substantially zero because the resin has the refractivity substantially similar to the substrate, and a reflection component is not included.

Moreover, as illustrated in FIG. 16, in the low reflective metal lamination, a chrome oxide or a chromium nitride is laminated so that reflection is reduced. According to a product level, reflectance is not more than 1% with respect to 550 nm wavelength. However, in a case where surrounding light is very strong, reflection of the surrounding light becomes undesired reflection which impairs proper display, even if the reflectance is not more than 1%. This causes a problem.

The undesired reflection from the ITO is accompanied by color due to an interference phenomenon, which is caused because the ITO is a thin film. Refractivity varies from ITO to ITO but ITO has a refractivity of about 2.0. In general, the ITO is formed by 1000 Å to 1500 Å in thickness. For example, when the film thickness is 1375 Å, the undesired reflection is minimalized. In this case, reflectance becomes substantially 0% with respect to 550 nm wavelength. As the wavelength becomes shorter or longer than 550 nm, the reflectance gradually increases (FIG. 17). Currently, a method for forming ITO film, which is most generally used, is a sputtering technique, by which the ITO film is formed such that unevenness of film thickness is about ±100 Å. FIG. 17 illustrates a graph of the dependency of reflectance upon film thickness, and FIG. 18 illustrates a x-y chromaticity diagram of reflection light, FIG. 17 and FIG. 18 illustrating the graph and the diagram, respectively, under the condition that the unevenness of the ITO film thickness is from +100 Å to −100 Å. According to FIG. 18, it is observed that a reflected color of reflection light remarkably changes within an expected unevenness of the ITO film thickness. As such, the ITO causes undesired reflection accompanied by a color, and this undesired reflection also gives rise to a problem with a display.

Thus, the undesired reflection from the ITO cannot be reduced by the technique disclosed in Japanese Unexamined Patent Publication, Tokukaihei, No. 3-156420.

As is clear from above, any of the arrangements includes impractical parts. Especially, the undesired reflection of the ITO is unconsidered.

[Patent Document 1] Japanese Patent No. 3575609 (published on Oct. 13, 2004)

[Patent Document 2] Japanese Patent No. 3410663 (published on May 26, 2003)

[Patent Document 3] Japanese Examined Utility Model Application Publication, Jitsukohei, No. 6-24812 (published on Jun. 29, 1994)

[Patent Document 4] Japanese Unexamined Patent Publication, Tokukaihei, No. 3-156420 (published on Jul. 4, 1991)

### DISCLOSURE OF INVENTION

As described above, the conventional arrangements cannot sufficiently reduce reflection of incident light from a front surface on a film surface. More specifically, with the conventional arrangements, the incident light on the front surface causes reflection from a front surface and a back surface of the protection plate 22, surface-reflection from the first substrate 31, and surface-reflection occurred inside the liquid crystal display panel (surface-reflection such as a boundary face formed by the BM or the ITO).

The present invention is accomplished in view of the problems discussed above. An object of the present invention is to realize a liquid crystal display device which can effectively reduce surface-reflection from each substrate and from inside a liquid crystal display panel.

In order to achieve the object, a liquid crystal display device of the present invention, which is operated in a circularly polarized light mode, includes: a liquid crystal display panel including a first substrate on an observer side, a second substrate on a backside, and a liquid crystal layer between the first and second substrates; and a protection plate which is provided on a front surface of the liquid crystal display panel via a space, wherein the protection plate includes a first optical member whose optical conditions are set such that incident light from the observer side becomes elliptically polarized light after passing through the protection plate and the first optical member, the elliptically polarized light being incident on the liquid crystal layer.

As such, the elliptically polarized light, obtained after the light passes through the first optical member from the observer side, reflects from a front surface of a liquid crystal display element in a state of the elliptically polarized light, and changes its direction. When the elliptically polarized light passes through the first optical member again, a polarization axis rotates by 90°, so that the light is blocked off. This makes it possible to effectively reduce undesired reflection.

Moreover, in a case of a reflective type, when the protection plate is provided with the first optical member which emits the elliptically polarized light, the elliptically polarized light can be incident on the liquid crystal layer from the observer side. Consequently, it is possible to use the member on which the elliptically polarized light is incident as the member for reducing the undesired reflection from inside the liquid crystal display device.

### BRIEF DESCRIPTION OF DRAWINGS

FIG. 1 is a cross sectional view illustrating an arrangement of a liquid crystal display device.

FIG. 2 is a view illustrating how to arrange optical axes.

FIG. 3 is a view illustrating a rubbing relative angle.

FIG. 4 is a view illustrating a relation between a liquid crystal retardation and transmittance.

FIG. 5 is a view illustrating a relation between a liquid crystal retardation and reflectance.

FIG. 6 (a) is a view illustrating a circularly polarized light mode in which a black display is carried out.

FIG. 6 (b) is a view illustrating a circularly polarized light mode in which a white display is carried out.

FIG. 7 (a) is a view illustrating a circular polarized light mode in which a black display is carried out.

FIG. 7 (b) is a view illustrating a circular polarized light mode in which a white display is carried out.

FIG. 8 is a view illustrating how much undesired reflection is to be reduced.

FIG. 9 is a view illustrating a rubbing relative angle.

FIG. 10 is a plan view illustrating an arrangement of a protection plate.

FIG. 11 (a) is a perspective view illustrating an arrangement of a case.

FIG. 11 (b) is a plan view illustrating an arrangement of a case.

FIG. 11 (c) is a cross sectional view illustrating an arrangement of a case, taken along arrows A-A′.

FIG. 12 is a cross sectional view illustrating an arrangement of a conventional liquid crystal display device.

FIG. 13 is a view illustrating undesired reflections in a liquid crystal display device.

FIG. 14 is a cross sectional view illustrating a conventional liquid crystal display device.

FIG. 15 is a cross sectional view illustrating a conventional liquid crystal display device.

FIG. 16 is a view illustrating reflectance of a low reflective chrome.

FIG. 17 is a view illustrating dependency of ITO spectral reflectance upon film thickness.

FIG. 18 is a view illustrating reflected color distribution according to ITO film thickness.

### BEST MODE FOR CARRYING OUT THE INVENTION

Explained is a liquid crystal display mode.

A TN (twisted nematic) mode is used as a general mode. A twist angle of a liquid crystal layer is arranged so as to be substantially 90°, and a nematic liquid crystal having a positive permittivity anisotropy is used. Linear polarized light is incident on the liquid crystal layer, and by using an optical rotation of the liquid crystal layer, an applied voltage causes a polarization direction of the incident linear polarized light to be switched so as to rotate from 90° to 0°.

The following describes a circularly polarized light mode, which is used in the present invention.

In this mode, the incident light from a light source or surrounding light is converted into substantially circularly polarized light via an optical member such as (i) a cholesteric film or (ii) a polarizing plate and a wave plate, and the substantially circularly polarized light thus converted is incident on a liquid crystal layer. This mode has a great advantage of being applicable to any of a reflective liquid crystal display device, a transmissive liquid crystal display device, and a transflective liquid crystal display device. The circularly polarized light mode includes a parallel alignment mode and a vertical alignment mode.

The parallel alignment mode is disclosed in Japanese Patent No. 3575609, and the vertical alignment mode is disclosed in Japanese Patent No. 3410663.

[Parallel Alignment Mode]

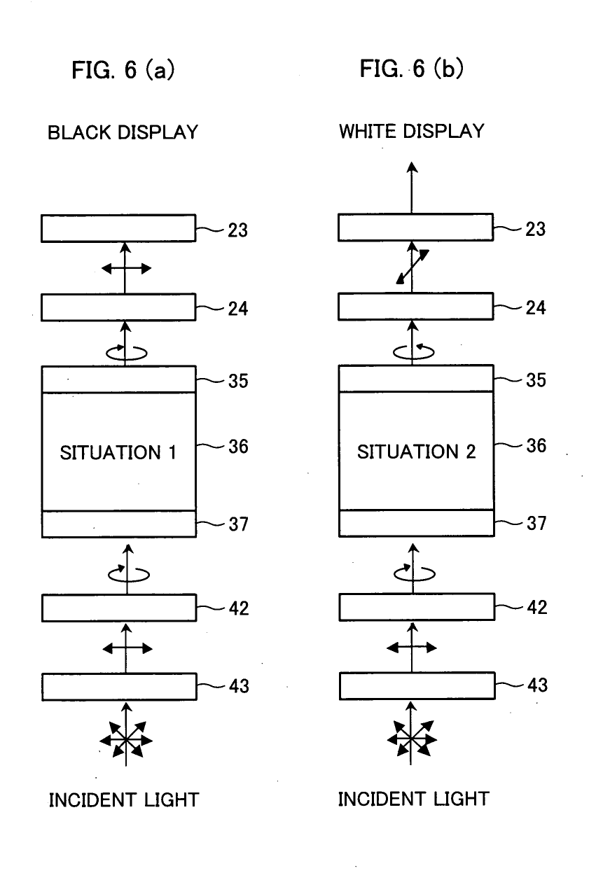

FIGS. 6 (a) and (b) are explanatory views illustrating a case where a parallel alignment mode is applied to a transmissive liquid crystal display. A material having a positive permittivity anisotropy is used as a liquid crystal material of a liquid crystal layer. A parallel alignment film, in which long axes of liquid crystal molecules are almost aligned parallel to a substrate when no voltage is applied, is used as a first alignment film and a second alignment film between which the liquid crystal layer is sandwiched. It is desirable that an alignment direction of liquid crystal by rubbing or the like be relatively from 110° to 180°, in upper lower parts of the liquid crystal layer, viewed from the observer side. The particulars are described later. Provided on an upper side of a liquid crystal layer 36 (on the observer side) are a first polarizing plate 23 and a first wave plate 24, and provided on a lower side of the liquid crystal layer 36 are a second wave plate 42 and a second polarizing plate 43. Each phase difference of the first wave plate 24 and the second wave plate 42 is arranged in its surface so as to satisfy a substantially quarter wave condition at least with respect to the light having a wavelength of 550 nm. The first polarizing plate 23 and the first wave plate 24 are generically referred to as a first optical member. The second wave plate 42 and the second polarizing plate 43 are generically referred to as a second optical member.

In Situation 2 (in which no voltage is applied to a liquid crystal, or a voltage is applied to the liquid crystal which voltage does not change an alignment direction of liquid crystal molecules), a retardation of the liquid crystal layer is arranged so as to satisfy a half wave condition at least with respect to the light having a wavelength 550 nm.

Incident light emitted from a light source is converted into substantially circularly polarized light after passing through the second polarizing plate 43 and the second wave plate 42, and is then incident on the liquid crystal layer 36. After passing through the liquid crystal layer 36, the direction of the circularly polarized light is reversed. Then the circularly polarized light is converted via the first wave plate 24 into linear polarized light which is parallel to a transmission axis of the first polarizing plate 23. Thus, a white display is obtained.

In Situation 1 (in which the retardation of the liquid crystal layer is gradually reduced in response to an applied voltage, and ultimately the retardation of the liquid crystal becomes substantially zero), the circularly polarized light, which is incident on the liquid crystal layer 36, passes through the liquid crystal layer 36 with little changes. The circularly polarized light is converted via the first wave plate 24 into linear polarized light which is perpendicular to the transmission axis of the first polarizing plate 23. Thus, a black display is obtained (normally white). A voltage falling within a range from a white display voltage to a black display voltage is used as a display voltage. When it is said that the retardation of liquid crystal is substantially zero, it includes (i) a case where the retardation is exactly zero and (ii) a case where, although the retardation is not exactly zero, the retardation is close to zero to such an extent that a performance that engineers intend (such as display quality) is obtained. The followings are the same as above.

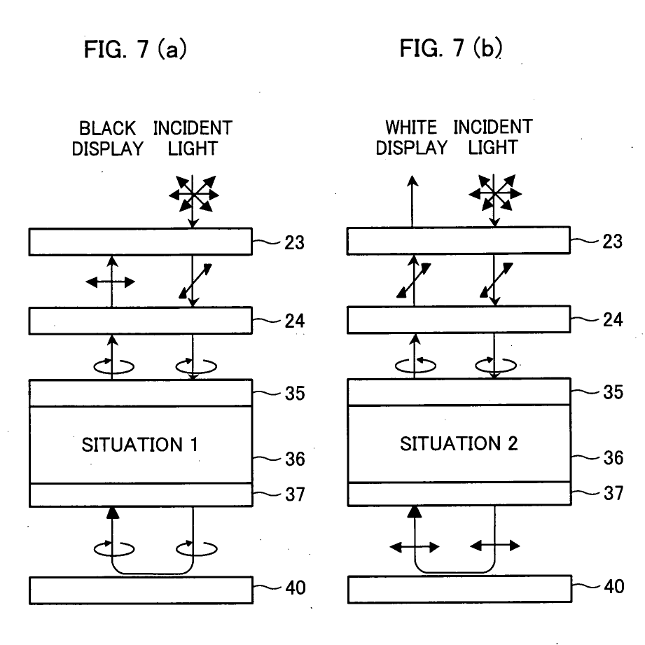

FIGS. 7 (a) and (b) are explanatory views illustrating a case where a parallel alignment mode is applied to a reflective liquid crystal display. A liquid crystal material, an alignment film material, and a rubbing angle are arranged similarly to the transmissive type.

In Situation 2 (in which no voltage is applied to a liquid crystal, or a voltage is applied to the liquid crystal which voltage does not change an alignment direction of liquid crystal molecules), a retardation of a liquid crystal layer is arranged so as to satisfy a quarter wave condition at least with respect to the light having a wavelength of 550 nm.

Surrounding light, incident from above (from an observer side), is converted into substantially circularly polarized light via a first polarizing plate 23 and a first wave plate 24, and is then incident on a liquid crystal layer 36. The substantially circularly polarized light is converted into linear polarized light when reaching a reflective film 40. The linear polarized light is reconverted into substantially circularly polarized light after passing through the liquid crystal layer 36 again. Then the substantially circularly polarized light is converted via the first wave plate 24 into linear polarized light which is parallel to a transmission axis of the first polarizing plate 23. Thus, a white display is obtained. In FIGS. 7 (a) and (b), a rotation direction which the circularly polarized light has just before being incident on the liquid crystal layer 36 is different from a rotation direction which the circularly polarized light has after being reflected from the reflective film 40 and then passing through the liquid crystal layer 36 again. Note however that the direction to which one of the lights travels is different by 180° from the direction to which the other of the lights travels. Therefore, both of the two lights have the same property.

In Situation 1 (in which the retardation of the liquid crystal layer is gradually reduced in response to an applied voltage, and ultimately the retardation of the liquid crystal becomes substantially zero), the substantially circularly polarized light, which is incident on the liquid crystal layer 36, is reflected from the reflective film 40 with little changes, turns its direction around, and passes through the liquid crystal layer 36 again. In Situation 1 of FIG. 7 (a), a polarization state which the circularly polarized light has just before reflection and a polarization state which the circularly polarized light has just after reflection are illustrated in the same rotation direction. Note however that the direction to which one of the lights travels is different by 180° from the direction to which the other of the lights travels. Therefore, the property of one of the circularly polarized lights is the reverse of that of the other of the circularly polarized lights. The circularly polarized light is converted via the first wave plate 24 into linear polarized light which is perpendicular to the transmission axis of the first polarizing plate 23. Thus, a black display is obtained.

When a transflective liquid crystal display device operates in the parallel alignment mode, a reflective region and a transmissive region are provided within each pixel. In each region, a transmissive section provides a display based on the same principle as that of the parallel alignment mode in which the transmissive liquid crystal display device operates, and a reflective section provides a display based on the same principle as that of the parallel alignment mode in which the reflective liquid crystal display device operates. When the thickness of a liquid crystal layer is optimized so that the same voltages such as white display, black display, or its half tone are applied to the reflective region and the transmissive region, respectively, the reflective region and the transmissive region within a single pixel are to be driven in accordance with the same voltage.

When a sufficiently high voltage is applied to electrodes provided on either side of the liquid crystal layer, which electrodes face each other, liquid crystal molecules rise perpendicularly to a surface of a substrate, so that the retardation of the liquid crystal layer is substantially zero. However, because a finite applied voltage is applied during black display (typically, around 5V), alignments of the liquid crystal molecules can not be sufficiently changed, thereby resulting in that a finite retardation remains in the liquid crystal layer. This retardation is hereinafter referred to as a “residual retardation”. Especially, because of anchoring effect of an alignment film, the liquid crystal molecules adjacent to a surface of the alignment film are not fully aligned at right angle even if a voltage for operating a liquid crystal display device is applied. This causes the retardation of the liquid crystal display not to become zero. On this account, the retardation of the first wave plate 24 is adjusted so that a black display is carried out even when a voltage falling within a practical range is applied. More particularly, in a case where the liquid crystal layer has a residual retardation of α, (i) a lag axis of the first wave plate 24 is adjusted to be almost conformed to an effective direction of a lag axis of the liquid crystal layer, and (ii) an optical retardation Re of the first wave plate 24 is arranged as below.

Re=λ/4−α (λ is a wavelength of light) Formula 1

This allows an entire liquid crystal display panel including the residual retardation to satisfy the quarter wave condition.

In another way, the lag axis of the first wave plate 24 is arranged perpendicularly to the effective lag axis of the liquid crystal layer, and the retardation Re of the first wave plate 24 is arranged as below.

Re=λ/4+α (λ is a wavelength of light) Formula 2

This allows the residual retardation to be canceled and the quarter wave condition to be satisfied.

In this way, the first wave plate 24 adjusts the residual retardation, thereby resulting in that not fully circularly polarized light, but elliptically polarized light, which is almost circularly polarized light, is incident on the liquid crystal layer of the reflective region. The “substantially circularly polarized light” in the Description includes not only the fully circularly polarized light, but also the elliptically polarized light which is arranged so as to adjust effects caused by the residual retardation of the liquid crystal layer.

The residual retardation differs depending on each physical property value of a liquid crystal material, the thickness of a liquid crystal layer, a setting of voltage, a rubbing relative angle, or the like but is typically, in a general purpose technique, not less than 5 nm and not more than 70 nm. Especially, as described in Embodiment 1, when the rubbing relative angle is 180°, the residual retardation typically occurs in a range of not less than 30 nm but not more than 70 nm.

On this account, in a parallel alignment mode, from the viewpoint of improving a contrast, the retardation Re of the first wave plate is determined in a range of not less than 68 nm but not more than 208, according to Formula 1 and Formula 2. The range is more preferably not less than 68 nm but not more than 108 nm, or not less than 168 nm but not more than 208 nm.

On the other hand, from the viewpoint of preventing undesired reflection, the effect becomes lowered as the first wave plate deviates from the quarter wave condition. That is, because the fully circularly polarized light is not incident on the liquid crystal display panel, some components are not absorbed by the first polarizing plate 23 when the undesired reflection occurs in members of the liquid crystal display panel. This results in that an observer receives the undesired reflection.

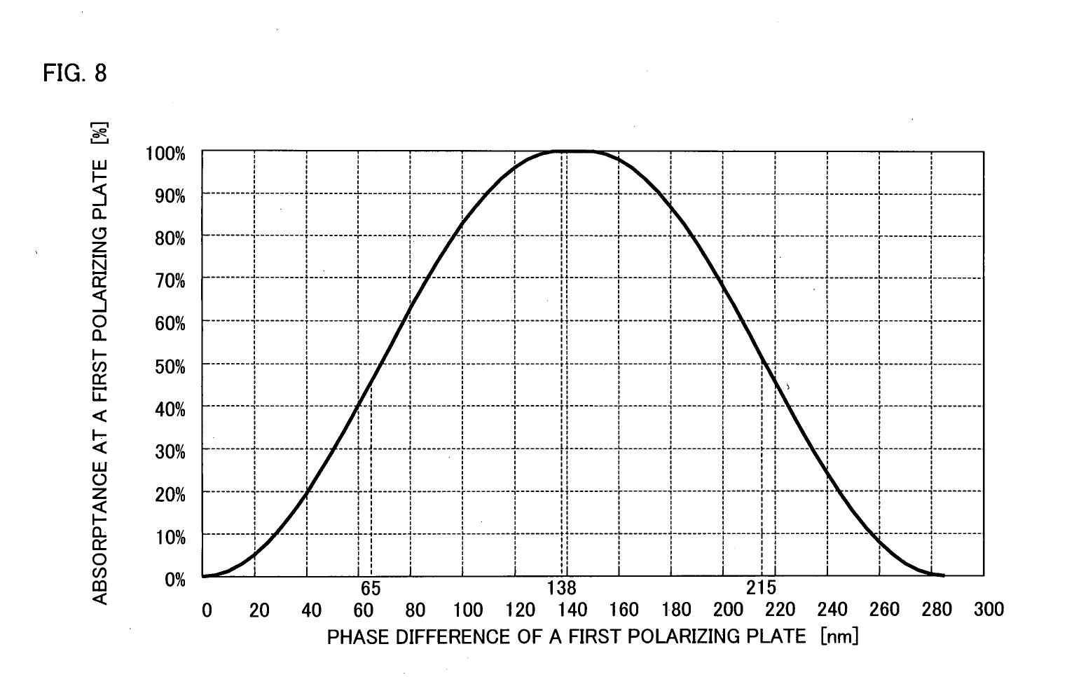

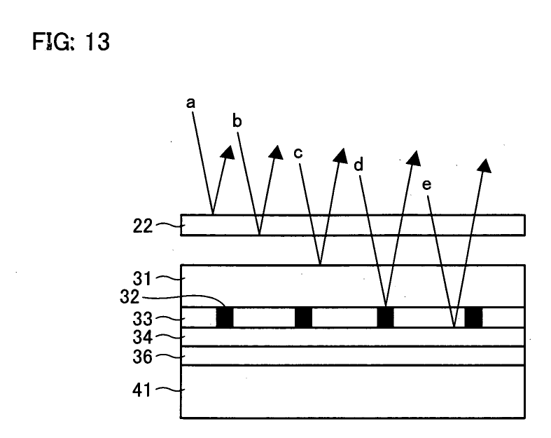

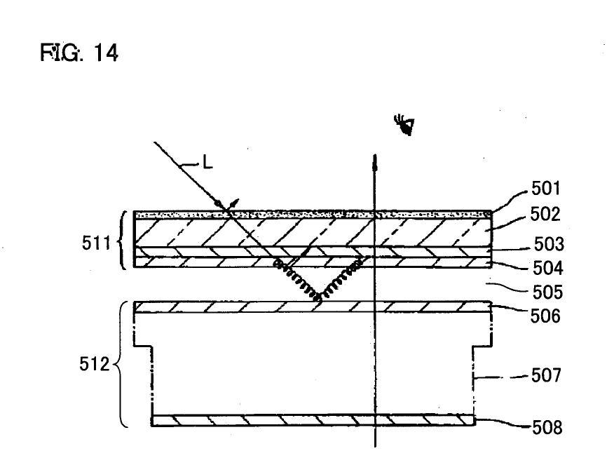

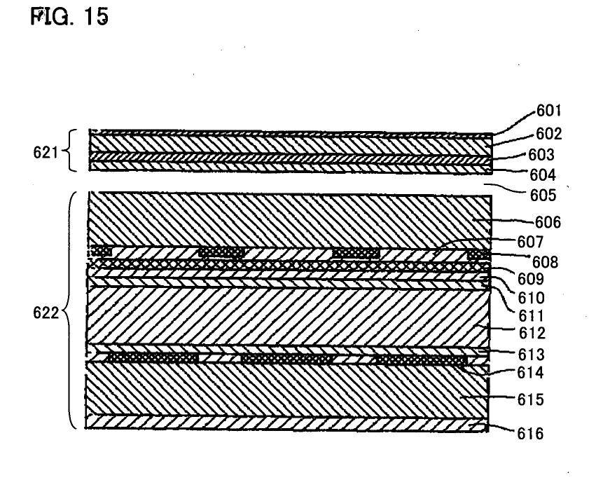

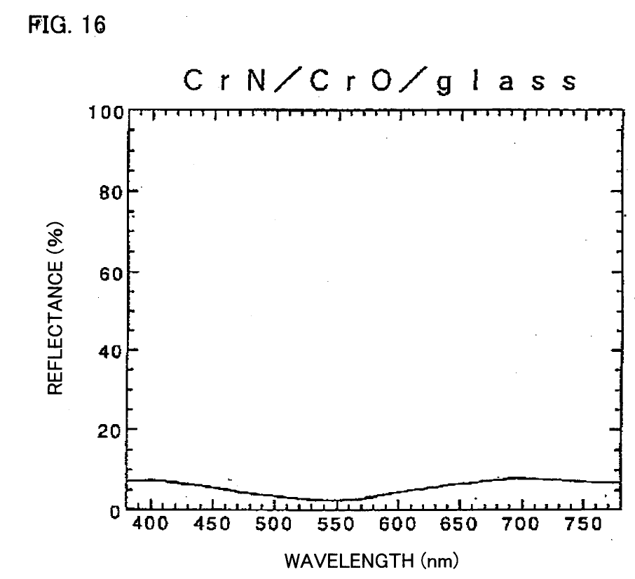

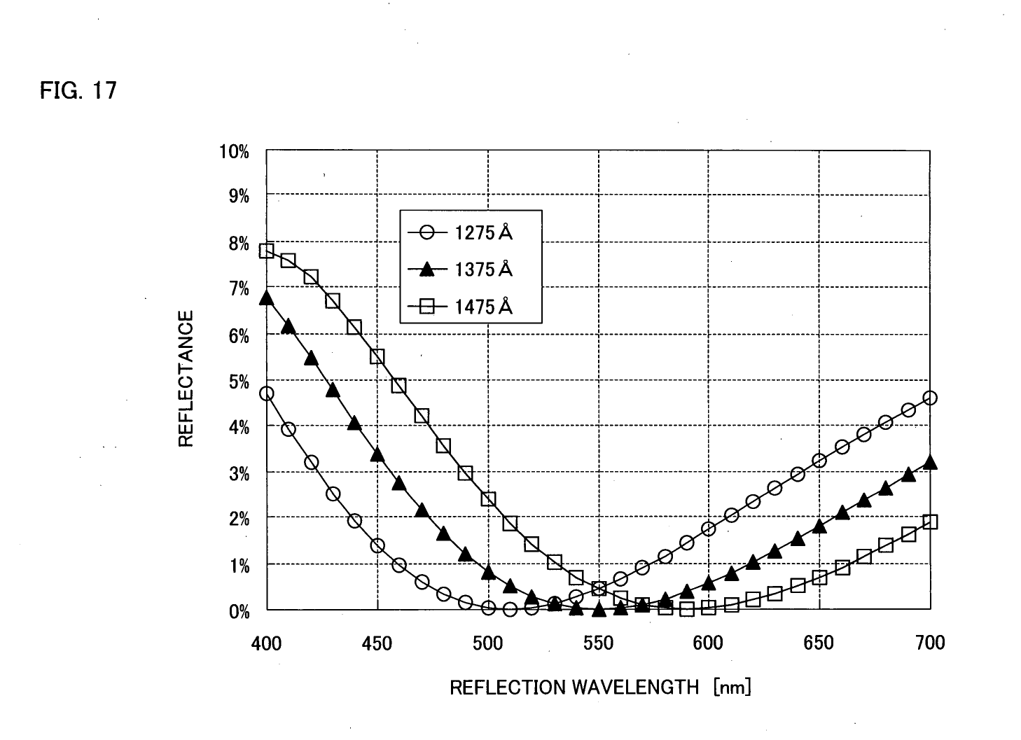

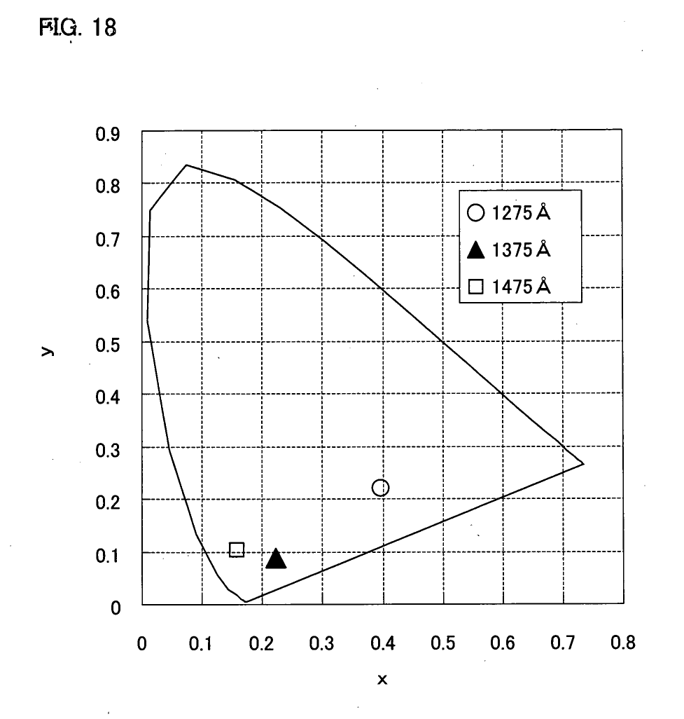

FIG. 8 illustrates how much undesired reflection which reaches an observer is to be reduced in response to a change in retardation of a first wave plate. More particularly, FIG. 8 illustrates calculations as to how much percentage of reflected light is absorbed by a first polarizing plate when, among incident light from an observer side, light reflected from a boundary face, which is likely to cause undesired reflection (arrows b, c, d, and e, illustrated in FIG. 13), is 100%. The calculations are carried out while changing the retardation of the first wave plate.

When, with respect to the light of 550 nm, the first wave plate has a retardation of 138 nm, which is a quarter wave condition, the first polarizing plate has an absorptance of 100% with respect to undesired reflection. This means that no undesired reflection reaches the observer side. As the retardation is away from the quarter wave condition, the absorptance of the first polarizing plate is gradually lowered. This means that the undesired reflection is directed toward the observer side. From the viewpoint of visibility, especially when the undesired reflection is reduced by half, it revealed that the remarkable effect was obtained. On this account, it is preferable that the retardation of the first wave plate 24 be set to not less than 65 nm but not more than 215 nm with respect to the light of 550 nm.

From the two viewpoints above, it is very important that the retardation of the first wave plate be not less than 68 nm but not more than 208 nm. It is more preferable that the retardation be not less than 68 nm but not more than 108 nm, or not less than 168 nm but not more than 208 nm.

This means that, when ellipticity is defined as follows:

(Minor axis of an ellipse)/(Major axis),
it is preferable that elliptically polarized light having an ellipticity of not less than 0.4 but not more than 1.0 be emitted, or elliptically polarized light having an ellipticity of not less than 0.4 but not more than 0.7 be emitted from the first optical member. This is applicable not only to the first optical member, but also to the second optical member.

As for a retardation of a second wave plate, there are two cases. Firstly, the retardation is to be designed so as to satisfy a quarter wave condition at least with respect to the light having a wavelength of 550 nm. In this case, incident light from a back surface is converted into a circularly polarized light, and then the circularly polarized light is incident on the liquid crystal layer. In view of a viewing angle characteristic, the retardation may be slightly away from the condition, but almost satisfies the quarter wave condition.

Secondly, the second wave plate compensates for a residual retardation of the liquid crystal layer. In this case, the retardation is designed to be away, by the residual retardation, from the quarter wave condition

When the incident light from the back surface passes through the second polarizing plate and the second wave plate, the elliptically polarized light having an ellipticity of 0.4 to 1.0 is incident on the liquid crystal layer, like the set value of the first wave plate.

[Vertical Alignment Mode]

FIGS. 6 (a) and (b) are explanatory views also illustrating a vertical alignment mode in which a transmissive liquid crystal display operates. Note that a material having a negative permittivity anisotropy is used as a liquid crystal material of a liquid crystal layer, and a vertical alignment film, in which long axes of liquid crystal molecules are aligned perpendicularly to a substrate when no voltage is applied, is used as alignment films between which the liquid crystal layer is sandwiched. Provided on an upper side of a liquid crystal layer (on an observer side) is a first wave plate 24, and provided on a lower side of the liquid crystal layer is a second wave plate 42. Each phase difference of the first wave plate 24 and the second wave plate 42 is arranged, in its surface, so as to satisfy a substantially quarter wave condition at least with respect to light having a wavelength of 550 nm.

In Situation 1 (in which no voltage is applied to a liquid crystal, or a voltage is applied to the liquid crystal which voltage does not change an alignment direction of liquid crystal molecules), the liquid crystal molecules are aligned perpendicularly to the substrate. Therefore, the liquid crystal layer has a retardation of zero. Incident light from a light source is converted into substantially circularly polarized light after passing through a second polarizing plate 43 and the second wave plate 42, and is then incident on a liquid crystal layer 36. The circularly polarized light, which is incident on the liquid crystal layer 36, passes through the liquid crystal layer 36 with little changes. The circularly polarized light is converted via the first wave plate 24 into linear polarized light which is perpendicular to a transmission axis of the first polarizing plate 23. Thus, a black display is obtained.

In Situation 2 (in which as the liquid crystal is inclined from a direction perpendicular to the substrate in response to an applied voltage, the retardation of the liquid crystal gradually increases and ultimately satisfy a half wave condition at least with respect to the light of 550 nm), the direction of the circularly polarized light, which is incident on the liquid crystal layer 36, is reversed after passing through the liquid crystal layer 36. The circularly polarized light is converted via the first wave plate 24 into linear polarized light which is parallel to the transmission axis of the first polarizing plate 23. Thus, a white display is obtained (normally black). A voltage falling within a range from a black display voltage to a white display voltage is used as a display voltage.

FIGS. 7 (a) and (b) are explanatory views illustrating a vertical alignment mode which is applied to a reflective liquid crystal display. A liquid crystal material and an alignment film material are the same as the transmissive type to which the vertical alignment mode is applied.

In Situation 1 (in which no voltage is applied to a liquid crystal, or a voltage is applied to the liquid crystal which voltage does not change an alignment direction of liquid crystal molecules), the liquid crystal molecules are aligned perpendicularly to a substrate. Therefore, a liquid crystal has a retardation of zero. Substantially circularly polarized light, which is incident on a liquid crystal layer 36, is reflected from a reflective film 40 with little changes, turns its direction around, and passes through the liquid crystal layer 36 again. The circularly polarized light is converted via a first wave plate 24 into linear polarized light which is perpendicular to a transmission axis of a first polarizing plate 23. Thus, a black display is obtained.

In Situation 2 (in which as the liquid crystal is inclined from a direction perpendicular to the substrate in response to an applied voltage, the retardation of the liquid crystal gradually increases and ultimately satisfy a quarter wave condition at least with respect to the light of 550 nm), surrounding light incident from above (from an observer side) is converted via the first polarizing plate 23 and the first wave plate 24 into substantially circularly polarized light, and is then incident on the liquid crystal layer 36. The substantially circularly polarized light is converted into linear polarized light when reaching a reflective film 40. The linear polarized light is reconverted into substantially circularly polarized light after passing through the liquid crystal layer 36 again. The substantially circularly polarized light is converted via the first wave plate 24 into linear polarized light which is parallel to the transmission axis of the first polarizing plate 23. Thus, a white display is obtained.

When a transflective liquid crystal display device operates in the vertical alignment mode, a reflective region and a transmissive region are provided within each pixel. In each region, a transmissive section provides a display based on the same principle as that of the vertical alignment mode in which the transmissive liquid crystal display device operates, and a reflective section provides a display based on the same principle as that of the vertical alignment mode in which the reflective liquid crystal display device operates. When the cell thickness of a liquid crystal layer is optimized so that the same voltages such as white display, black display, or its half tone are applied to the reflective region and the transmissive region, respectively, the reflective region and the transmissive region within a single pixel are to be driven in accordance with the same voltage.

Note that in the case where the vertical alignment mode is applied, the wave plates are arranged differently from the parallel alignment mode. In the vertical alignment mode, when a black display voltage is applied, the liquid crystal molecules of the liquid crystal layer are entirely aligned perpendicularly to the substrate. This allows a phase difference of the liquid crystal layer to be almost zero and no residual retardation to occur. From this reason, the first wave plate 24 and the second wave plate 42 are arranged to satisfy the quarter wave condition.

The followings are the same and difference between each Embodiment.

A transflective type is used in Embodiments 1 through 3.

In Embodiments 1 and 2, a liquid crystal display mode is a parallel alignment mode. A material having a positive permittivity anisotropy is used as a liquid crystal material. A parallel alignment film is used as a first alignment film and a second alignment film

In Embodiment 1, a rubbing relative angle is 180°, and in Embodiment 2, a rubbing relative angle is 110°.

In Embodiment 3, a liquid crystal display mode is a vertical alignment mode. A material having a negative permittivity anisotropy is used as a liquid crystal material. A vertical alignment film is used as a first alignment film and a second alignment film.

### Embodiment 1

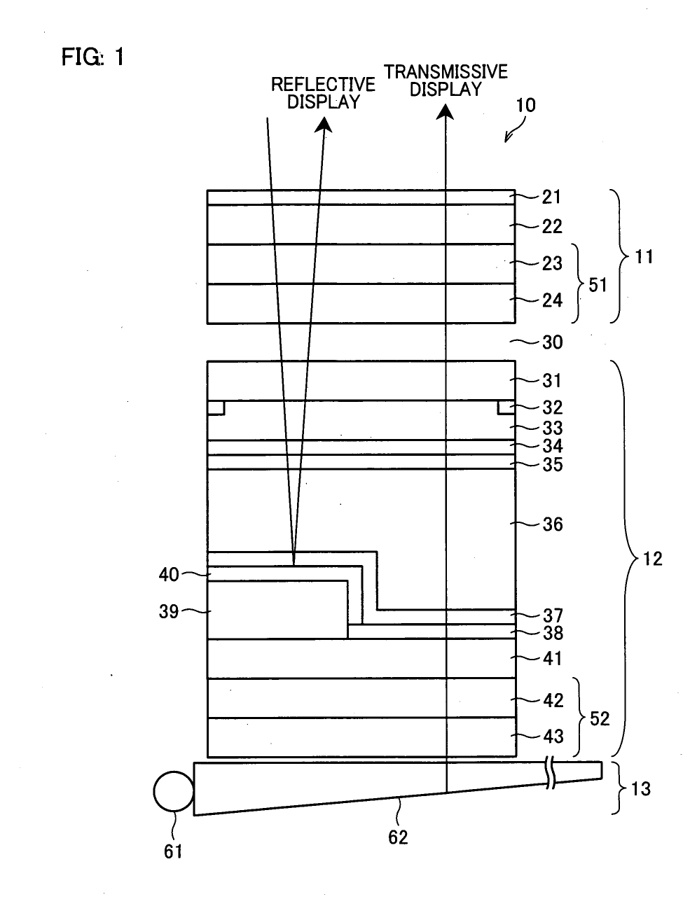

FIG. 1 illustrates an arrangement of a liquid crystal display device of this embodiment. Either of a transmissive type and a reflective type can be used in order to attain the present invention. In view of a mobile device which requires a protection plate, a transflective type is used in this embodiment in consideration of visibility when the mobile device is used in or out of doors. Explained is a particular arrangement as follows.

A liquid crystal display device of this embodiment has an arrangement in which, in the order of being close to an observer (in FIG. 1, from an upper side), a protective section 11, a space 30, a liquid crystal display panel 12 and a light source section 13 are laminated.

The protective section 11 includes, in the order of being close to the observer, an antireflective film 21, a protection plate 22, a first polarizing plate 23, and a first wave plate 24.

In this embodiment, the antireflective film 21 is provided. Even if the antireflective film 21 is not provided, the similar effect can be obtained. Moreover, the first polarizing plate 23 and the first wave plate 24 are provided on a backside of the protection plate 22. The first polarizing plate 23 and the first wave plate 24 may be provided on either a front side or a backside of the protection plate, provided that the first polarizing plate 23 and the first wave plate 24 are laminated in this order from the observer side. Alternatively, the first polarizing plate 23 may be provided on the front side of the protection plate, while the first wave plate 24 may be provided on the backside of the protection plate.

The liquid crystal display panel 12 includes, in the order of being side close to the observer, a first substrate 31, a color filter 33, a first ITO film (first transparent electrode) 34, a first alignment film 35, a liquid crystal layer 36, a second substrate 41, a second wave plate 42, and a second polarizing plate 43.

Those constituents may not come into contact with each other. Specifically, any of various optical films for improving viewing angle characteristic or deformation prevention films may be provided between respective films.

In a transmissive section (in FIG. 1, a right half), a second alignment film 37 and a second ITO film 38 (second transparent electrode) are laminated between the liquid crystal layer 36 and the second substrate 41, in the order of being close to the liquid crystal layer 36. In a reflective section (in FIG. 1, a left half), the second alignment film 37, a reflective film 40, and a third alignment film 39 are laminated between the liquid crystal layer 36 and the second substrate 41 in the order of being close to the liquid crystal layer 36. In this embodiment, aluminum is used for the reflective film 40 so as to work as an electrode. The reflective film 40 and the electrode of the reflective section can be individually provided. A resin is provided in the reflective section so that the liquid crystal layer 36 in the reflective section is provided thinner than the liquid crystal layer in the transmissive section. In order to apply a same voltage to the reflective section and the transmissive section, respectively, within a single pixel, the reflective film 40 comes into contact with the first ITO film 34.

The first polarizing plate 23 and the first wave plate are generically referred to as a first optical member 51. The second wave plate 42 and the second polarizing plate are generically referred to as a second optical member 52.

The light source section 13 includes a light source and a light guide plate 62.

It is desirable that a black matrix be provided between the first substrate 31 and the color filter 33, between the color filter 33 and the first ITO film 34, or in the color filter 33. There are two reasons for providing the black matrix. A first reason is to prevent color mixture of the color filter so that a contrast is improved, and a second reason is to prevent an improper operation of a TFT caused by external incident light.

An acrylic resin such as PMMA (polymethilmethacrylate), an inorganic glass, or a polycarbonate is used as For the protection plate 22 serving as a supporting substrate, provided that the protection plate 22 is a transparent substrate.

The following description deals with the liquid crystal layer and the wave plate.

A material having a positive permittivity anisotropy is used as a liquid crystal material, and a parallel alignment film is used as the first alignment film and the second alignment film.

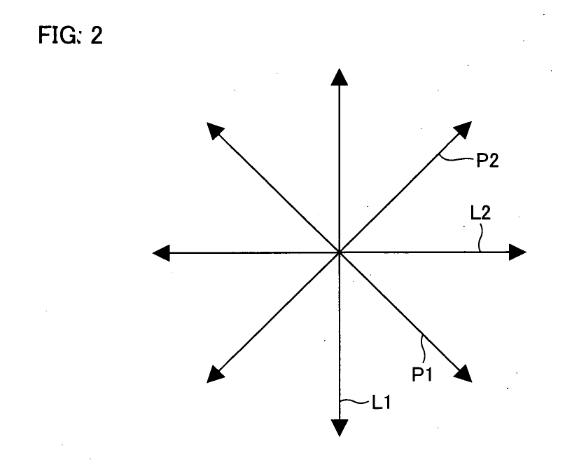

FIG. 2 illustrates a relation between a lag axis of each wave plate and a transmission axis of each polarizing plate, when viewed from an observer side. P1 indicates a transmission axis of the first polarizing plate 23. L1 indicates a lag axis of the first wave late 24. P2 indicates a transmission axis of the second polarizing plate 43. L2 indicates a lag axis of the second wave plate 42. The transmission axis P1 of the first polarizing plate and the lag axis L1 of the first wave plate are arranged such that an angle between the axes L1 and P1 is 45°, when viewed from the observer side. Similarly, the transmission axis P2 of the second polarizing plate and the lag axis L2 of the second wave plate are arranged such that an angle between the axes L1 and P1 is 45°. L1 and L2 are orthogonal to each other and P1 and P2 are orthogonal to each other. This is because when the lag axis L1 of the first wave plate is arranged to be orthogonal to the lag axis L2 of the second wave plate, it is possible to reduce the wavelength-dependency which the first wave plate normally essentially has.

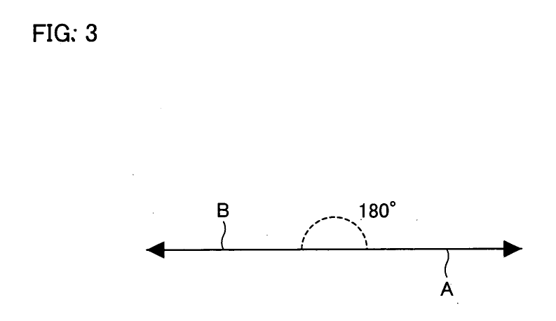

In FIG. 3, A indicates a rubbing direction of a first alignment film 35, and B indicates a rubbing direction of a second alignment film 37. An angle between the rubbing directions (rubbing relative angle) is 180°. In regard to a relation between (i) the setting of axes of each wave plate and each polarizing plate illustrated in FIG. 2 and (ii) the rubbing directions illustrated in FIG. 3, L2 and A are, for example, illustrated in the same direction, but not necessary to be arranged in such a manner.

A liquid crystal display mode of this embodiment is set to a parallel alignment mode. In a transmissive display, a white display is carried out when no voltage is applied (Situation 2 of FIG. 6 (b)), and a black display is carried out when a voltage is applied (Situation 1 of FIG. 6 (a)). Moreover, in a reflective display, a white display is carried out when no voltage is applied (Situation 2 of FIG. 7 (b)), and a black display is carried out when a voltage is applied (Situation 1 of FIG. 7 (a)).

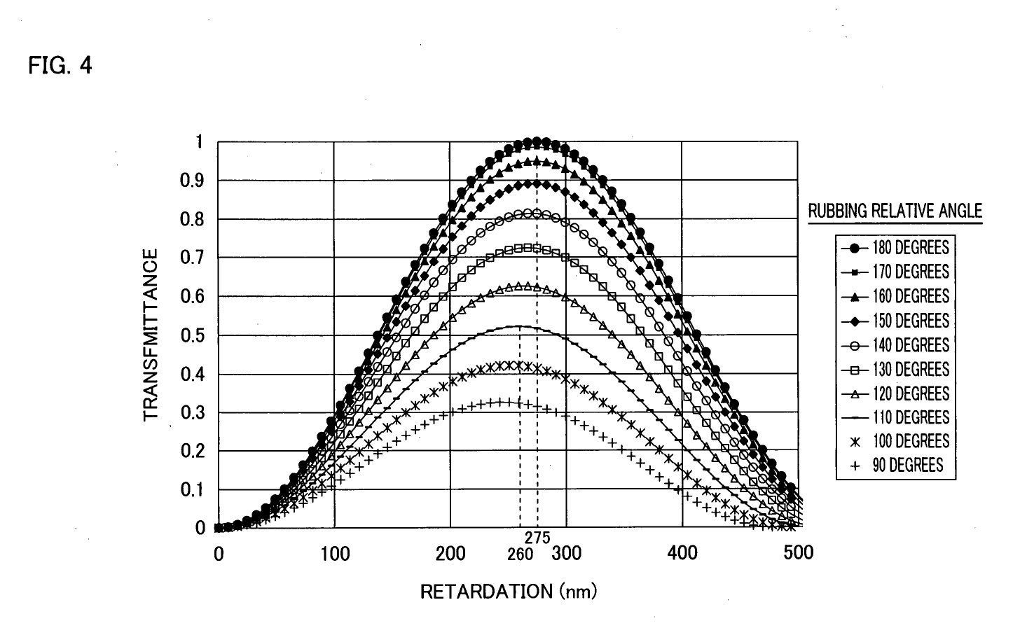

FIG. 4 illustrates how a transmittance of light having a wavelength of 550 nm varies depending on (i) a retardation of a liquid crystal and (ii) an angle between rubbing directions of upper and lower substrates (rubbing relative angle). In a case where the rubbing relative angle is arranged 180°, a transmissive display section provides the brightest white display when the liquid crystal has a retardation of 275 nm (the half wave condition with respect to the light having a wavelength of 550 nm). On this account, a thickness of the liquid crystal layer in the transmissive section was determined so that the liquid crystal has a retardation of 275 nm with respect to the light having a wavelength of 550 nm when a voltage is applied.

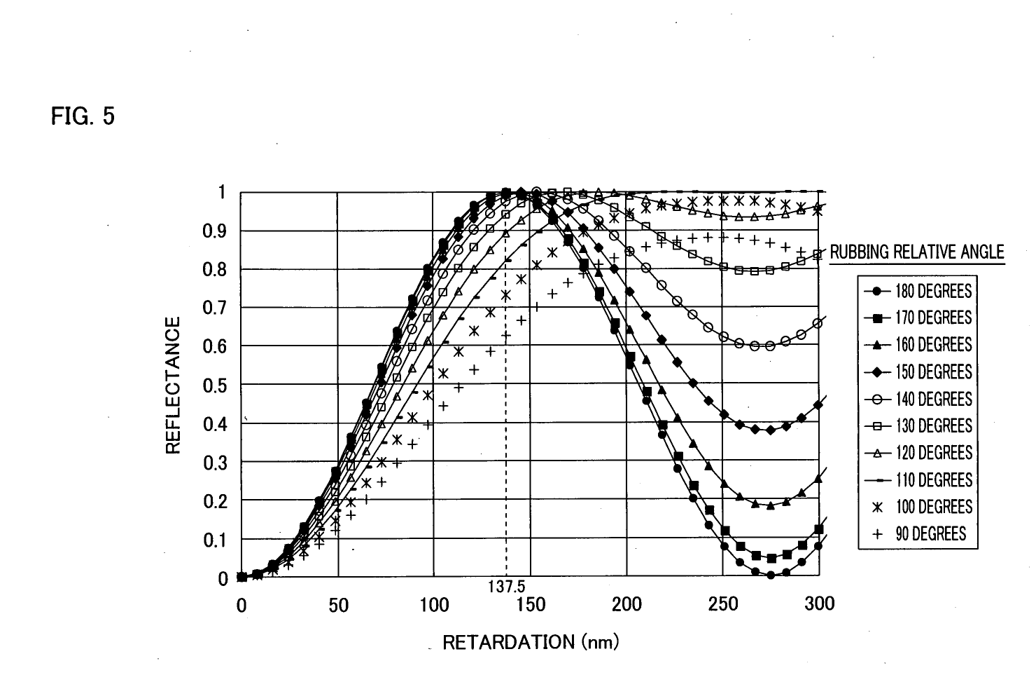

According to FIG. 5, a reflective display section provides the brightest white display when the liquid crystal has a retardation of 138 nm (the quarter wave condition with respect to the light having a wavelength of 550 nm). On this account, a thickness of the liquid crystal layer in the reflective section was determined so that the liquid crystal has a retardation of 138 nm with respect to the light having a wavelength of 550 nm when a white display voltage is applied.

The arrangement allowed a display to be bright and high contrast in either of the transmissive display and the reflective display. Especially, in strong sunlight out of doors, the high contrast was maintained. It appears that since (i) all of the undesired reflections from the back surface of the protection plate 22 (the arrow b in FIG. 13), from the front surface of the liquid crystal display panel (the arrow c in FIG. 13), and from inside the liquid crystal display panel 12 (arrows d and e in FIG. 13) were carried out in a state of substantially circularly polarized light, and (ii) linear polarized light, which is perpendicular to the transmission axis of the first polarizing plate 23, is obtained via the first wave plate 24, most of the undesired reflections were absorbed, thereby resulting in that the undesired reflections could be drastically reduced.

When the first optical member is provided on the back surface of the protection plate so as to emit substantially circularly polarized light, the substantially circularly polarized light is incident on the liquid crystal layer, and the undesired reflection is reduced at the same time. In this way, the first optical member is used both as a member to emit the substantially circularly polarized light to the liquid crystal layer, and as a member to reduce the undesired reflection. Moreover, it is not necessary to provide a wave plate (quarter wave plate) on the front of the liquid crystal display panel (on an observer side), unlike the conventional methods (Japanese Examined Utility Model Application Publication, Jitsukohei, No. 6-24812, and Japanese Unexamined Patent Publication, Tokukaihei, No. 3-156420).

Note that as has already been described, in the parallel alignment mode, even when a black display voltage is applied, a phase difference of the liquid crystal layer 36 cannot be exactly zero, and a residual retardation occurs. For this reason, a phase difference of the first wave plate is set so as to deviate from the quarter wave condition.

### Embodiment 2

This embodiment deals with an arrangement in which the parallel alignment mode is applied but the rubbing directions of Embodiment 1 are changed. The following describes a particularly different point. Other points except for the different point are similar to Embodiment 1.

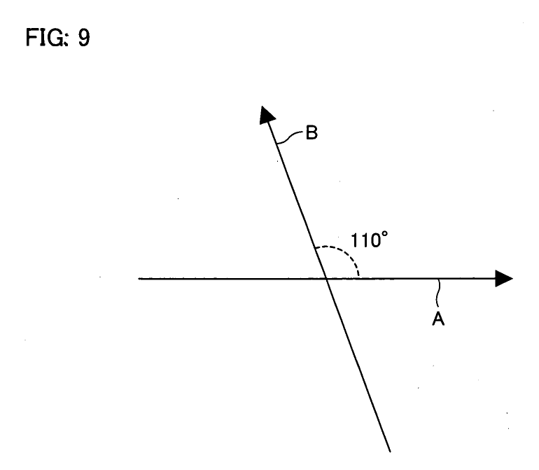

In FIG. 9, A indicates a rubbing direction of a first alignment film 35, and B indicates a rubbing direction of a second alignment film 37. An angle between the rubbing directions (rubbing relative angle) is 110°. In regard to a relation between (i) the setting of axes of each wave plate and each polarizing plate illustrated in FIG. 2 and (ii) the rubbing directions illustrated in FIG. 3, L2 and A are, for example, illustrated in the same direction, but not necessary to be arranged in such a manner.

In a transmissive display, a white display is carried out when no voltage is applied (Situation 2 of FIG. 6 (b)), and a black display is carried out when a voltage is applied (Situation 1 of FIG. 6 (a)). In a reflective display, a white display is carried out when no voltage is applied (Situation 2 of FIG. 7 (b)), and a black display is carried out when a voltage is applied (Situation 1 of FIG. 7 (a)).

According to FIG. 4, in a case where the rubbing relative angle is set to 110°, a transmissive display section provides the brightest white display when a liquid crystal has a retardation of 260 nm. On this account, a cell thickness of the liquid crystal layer in the transmissive section was determined so that the liquid crystal has a retardation of 260 nm with respect to light of 550 nm.

FIG. 5 reveals that in a reflective display section, when the liquid crystal layer is set to have a retardation of not less than 200 nm but not more than 300 nm, reflectance becomes greatest. The setting of the retardation of the liquid crystal layer was determined so that a natural white display is to be obtained when a white display is carried out while not only the light of 550 nm, but also all visible lights are incident.

Compared with Embodiment 1, a higher uniformity of brightness was attained in this embodiment because of the following reason. Since, in the reflective display, as illustrated in FIG. 5, a range of the retardation, where the reflectance is greatest, is broader when the rubbing relative angle is 110° than when the rubbing relative angle is 180°, it is difficult for unevenness of thickness of the liquid crystal layer to be observed as display unevenness.

Embodiment 1 and this embodiment merely deal with the cases where the rubbing relative angles are 110° and 180°. According to FIGS. 4 and 5, however, even when the rubbing relative angles are ones other than 110° and 180°, it is also possible that a display is carried out with bright and high contrast in both of the reflective region and the transmissive region. However, when a rubbing relative angle is less than 110°, the greatest transmittance becomes less than 50% in the transmissive display, and the greatest reflectance does not appear in the reflective display (no peak value appears). Therefore, such a rubbing relative angle is inappropriate. From this viewpoint, it is figured out that a rubbing relative angle, which is suitable for the circularly polarized light mode using a parallel alignment film, is from 110° to 180°. A value found by subtracting the rubbing relative angle from 180 corresponds to a twist angle of the liquid crystal layer. Accordingly, the twist angle of the liquid crystal is preferably not less than 0° but not more than 70°.

### Embodiment 3

The following description deals with an arrangement of this embodiment in which the vertical alignment mode is applied to the liquid crystal layer of Embodiment 1. The following describes a particularly different point. Other points except for the different point are similar to Embodiment 1.

A material having a negative permittivity anisotropy is used as a liquid crystal material, and a vertical alignment film is used as each of first and second alignment films.

Transmission axes of a first polarizing plate and a second polarizing plate and lag axes of a first wave plate and a second wave plate are arranged as illustrated in FIG. 2, similarly to Embodiment 1.

In a transmissive display, a black display is carried out when no voltage is applied (Situation 1 of FIG. 6 (a)), and a white display is carried out when a voltage is applied (Situation 2 of FIG. 6 (b)). In a reflective display, a black display is carried out when no voltage is applied (Situation 1 of FIG. 7 (a)), and a white display is carried out when a voltage is applied (Situation 2 of FIG. 7 (b)).

A retardation of a liquid crystal layer was set in each of a transmissive section and a reflective section in accordance with a thickness of the liquid crystal layer so that a bright display is carried out in each of the sections when a white display is carried out. The reflective section was electrically connected to the transmissive section so that the same voltage was applied to each of the liquid crystal layers in the reflective section and the transmissive section.

In the case of the vertical alignment mode, when a black display is carried out, the liquid crystal has a retardation of almost zero. On this account, unlike the parallel alignment mode, it was set that the first wave plate had a retardation so that a quarter wave condition was satisfied (with respect to light of 550 nm).

The arrangement allowed a realization of a liquid crystal display device in which both of the transmissive display and the reflective display are bright and have high contrast. Especially, with respect to visibility in strong sunlight out of doors, the high contrast was maintained. It appears that since (i) all the undesired reflection from a back surface of a protection plate (the arrow b in FIG. 13), from a front surface of a liquid crystal display panel (the arrow c in FIG. 13), and from inside the liquid crystal display panel (arrows d and e in FIG. 13) were carried out in a state of substantially circularly polarized light, and (ii) linear polarized light, which is perpendicular to the transmission axis of the first polarizing plate 23, is obtained via the first wave plate 24, most of the undesired reflections were absorbed, thereby resulting in that the undesired reflections could be drastically reduced.

Moreover, in this Embodiment, the high contrast was maintained in stronger external light, as compared with Embodiments 1 and 2. The reason for this appears to be as follows. The first wave plate has a retardation which deviates from the quarter wave condition according to Embodiments 1 and 2, whereas the first wave plate has a retardation which satisfies the quarter wave condition according to this embodiment. This allows the undesired reflection (arrows b, c, d, and e in FIG. 13) to be reflected in a state of fully circularly polarized light, so that the first polarizing plate has an absorptance of almost 100%.

It is preferable that an antistatic treatment be performed respectively for the back surface of the protection plate 22 (a surface facing the space 30) and the front surface of the liquid crystal display panel 12 (a surface of the first substrate facing the space 30) in each embodiment.

The antistatic treatment indicates that a technique such as a chemical etching, a plating treatment, an antistatic material coating, or an antistatic material application is carried out.

Various techniques are proposed as such antistatic treatment and either technique is applicable to the present invention, but it is desirable that after the treatment, transmittance be hardly reduced, scattering be hardly caused, performance of a layer to be treated be not reduced, birefringence be not caused.

When the treatment is performed, even if dust comes into the space 30 below the protection plate 22, it is possible to easily remove the dust and prevent a display inhibition which is caused when the dust attaches to the back surface of the protection plate 22 (the surface facing the space 30) or the front surface of the liquid crystal display panel (the surface of the first substrate facing the space 30).

Moreover, the liquid crystal display device 10 of each embodiment includes a light-shielding region on the periphery of the protection plate 22. The light-shielding region (example: a peripheral black 22b) is a member having functions of such as complementing a display, and restraining reflection from a surface of the periphery. It is possible to prepare a light-shielding region, for example, by applying a black coating material or the like to the front surface or the back surface of the periphery of the protection plate.

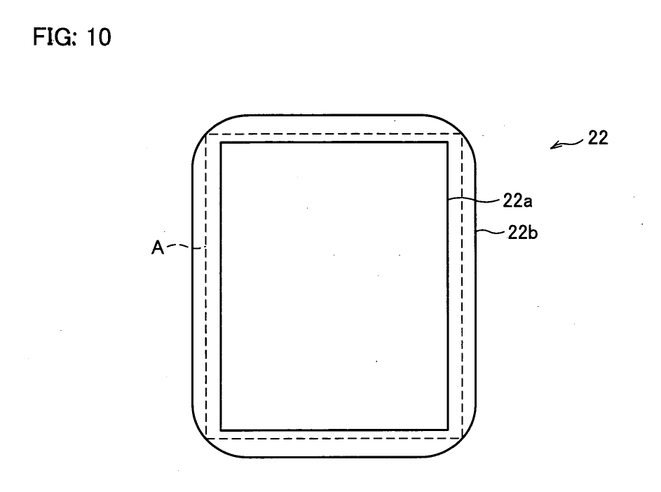

It is preferable that each side of the first wave plate 24 and the first polarizing plate 23 is arranged to locate within the peripheral black 22b. The arrangement makes it possible to suppress directing of the undesired scattered light from an edge face of the first polarizing plate 23 and the wave plate 24 toward the observer. As illustrated in FIG. 10, the protection plate 22 includes a section, which is not used for a display (an black area 22b), around a display section 22a which contributes to an actual display. Such a section is defined as a “peripheral black”. A line indicated by A illustrates a position where the edge sections of the first polarizing plate 23 and the first wave plate 24 are located.

Generally, an edge of the first polarizing plate or the first wave plate has a behavior which causes light scattering. Therefore, when surrounding light from the observer side or light from the light source of the back surface is incident on the edge sections of the first polarizing plate and the first wave plate, the light scattering which has an adverse affect on a display is caused (hereinafter referred to as “undesired scattering”).

With the above arrangement, it is possible to avoid that the surrounding light from the observer side is incident on the edge sections of the first polarizing plate 23 and the first wave plate 24. Moreover, when the light from the light source of the back surface is incident on the first polarizing plate 23 and the first wave plate 24, the undesired scattering is caused. Even in such case, the arrangement makes it possible to prevent the undesired scattering light from directing toward the observer.

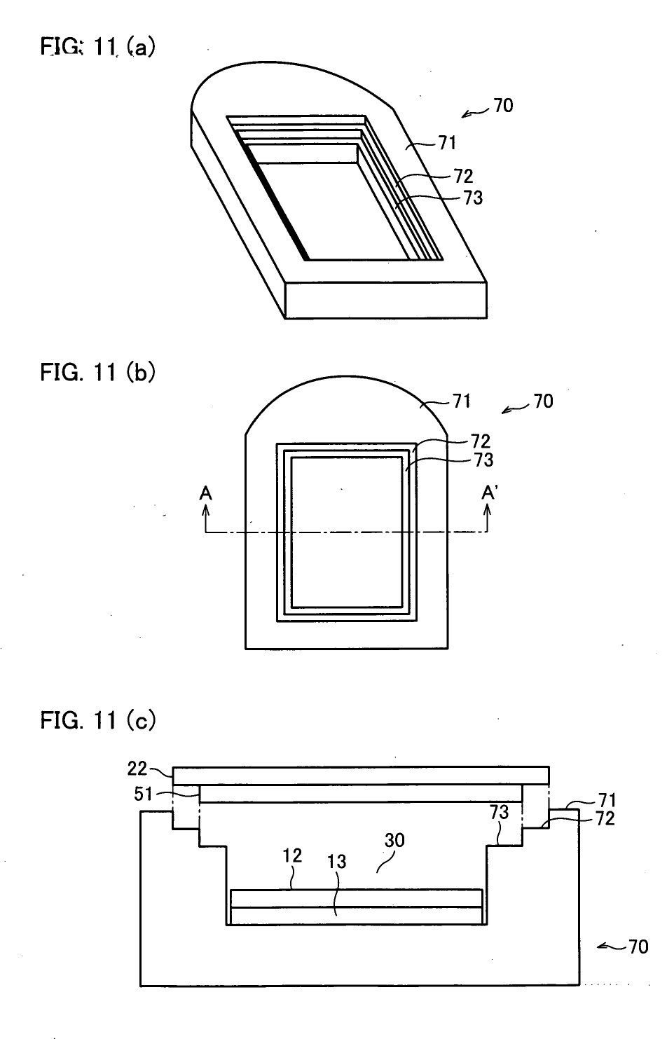

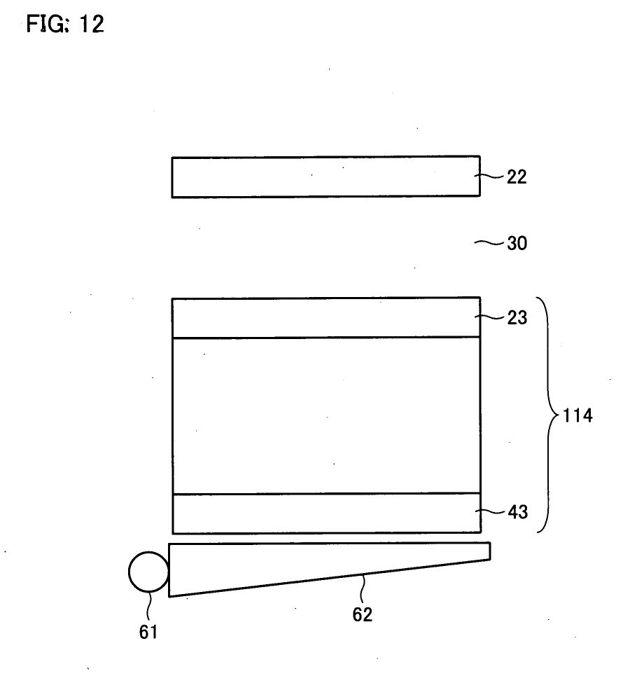

In the liquid crystal display device 10 of each embodiment, a case for covering the liquid crystal display device may be arranged such that a section on which the liquid crystal display device is provided has a shape of a first and a second steps descending from a front surface side, as illustrated in FIGS. 11 (a) through (c).

More particularly, a case section on which the protection plate 22 is provided may include two steps (72 and 73) in such a manner that an edge section of the protection plate 22 fits into a first step 72, and an edge section of the first optical member 51 including the first polarizing plate 23 and the first wave plate 24 fits into a second step 73.

With the arrangement illustrated in FIGS. 11 (a) through (c), when a case 70 is opaque, it is restrained that the light from the light source of the back surface is incident on the edge section of the first optical member 51. This makes it possible to reduce occurrence of the undesired scattering. Moreover, the first step 72 allows the protection plate 22 to be adhered to the case not only on its side surface, but also on its bottom surface, thereby resulting in that an adhesive force is improved, as compared with a case having only one step.

With the arrangement, the protection plate 22 does not easily come off, and dust can be prevented from coming in from outside. Moreover, this can avoid light leakage caused by the undesired scattering at the edge section of the protection plate 22.

In the liquid crystal display device 10 of each of the embodiments, a deformation prevention film may be further provided on the front surface of the protection plate, which deformation prevention film is a film having the same thermal shrinkage rate as the first optical member provided at the back surface of the protection plate 22 (the surface facing the space 30).

In each of the embodiments, the antireflective film 21 also works as a deformation prevention film. Alternatively, it is possible to arrange such that the first polarizing plate 23 is provided on the surface of the observer side of the protection plate 22, and the first wave plate 24 is provided on the back surface (the surface facing the space 30) of the protection plate 22.

With the arrangement, it is possible to prevent the protective section from being deformed, or coming off from the case due to the deformation caused by the difference in thermal shrinkage rate between the first optical member and the protection plate.

Optical conditions of the first optical member, for example, can be designed such that, after passing through the protection plate and the first optical member, incident light having a wavelength of 550 nm, which is incident from the observer side, becomes elliptically polarized light whose ellipticity is not less than 0.4 but not more than 1.0.

In addition to the above arrangement, the liquid crystal display device of the present invention includes a reflective section provided on a side of the liquid crystal layer of the second substrate, which reflective section reflects incident light from the observer side.

With the arrangement, the liquid crystal display device of the present invention can be used as a reflective display device or a transflective display device.

In addition to the above arrangement, in the liquid crystal display device of the present invention, the second substrate includes a second optical member whose optical conditions are set such that incident light from a back surface opposite to the observer becomes elliptically polarized light after passing through the second optical member.

As described above, in each of the transmissive type or the transflective type, when the second substrate is provided with the second optical member, which emits the elliptically polarized light, the elliptically polarized light can be incident on the liquid crystal layer from the back surface opposite to the observer.

The optical conditions of the second optical member, for example, can be designed such that, after passing through the protection plate and the second optical member, incident light from the back surface opposite to the observer side becomes elliptically polarized light whose ellipticity is not less than 0.4 but not more than 1.0.

This also allows the elliptically polarized light to be incident on the liquid crystal layer in the transmissive display, as a counterpart of the first optical member.

Moreover, in addition to the above arrangement, in the liquid crystal display of the present invention, the liquid crystal layer is made of a liquid crystal material having a negative permittivity anisotropy, and when no voltage is applied, the liquid crystal layer has a retardation of zero at least with respect to the light having a wavelength 550 nm so that a black display is carried out.

When it is said that the retardation of liquid crystal is zero, it includes (i) a case where the retardation is exactly zero and (ii) a case where, although the retardation is not exactly zero, the retardation is close to zero (substantially zero) to such an extent that a performance that engineers intend (such as display quality) is obtained.

In addition to the above arrangement, in the liquid crystal display device, the liquid crystal layer is made of a liquid crystal material having a positive permittivity anisotropy; the first optical member includes a first linear polarizing plate and a first wave plate; and the first wave plate is arranged such that, when reaching the reflective section, the elliptically polarized light, which is incident on the liquid crystal layer, becomes nearly circularly polarized light at least with respect to the light having a wavelength of 550 nm when a voltage is applied.

In addition to the above arrangement, in the liquid crystal display device of the present invention, the first optical member includes a first linear polarizing plate and a first wave plate, the first wave plate has, in its in-plane direction, a retardation of not less than 68 nm and not more than 208 nm with respect to the light having a wavelength of 550 nm, and the liquid crystal layer is made of a liquid crystal material having a positive permittivity anisotropy so that a white display is carried out when a voltage is applied.

In addition to the above arrangement, in the liquid crystal display device of the present invention, an antistatic treatment is performed for each surface, facing the space, of the protection plate and the first substrate.

In addition to the above arrangement, in the liquid crystal display device, the protection plate includes a light-shielding region in its periphery, and each side of the first optical member is located within the light-shielding region.

In addition to the above arrangement, the liquid crystal display device of the present invention further includes a case for holding the protection plate, the first optical member, and the liquid crystal display panel such that, when the liquid crystal display device is viewed from the observer side, each side of the protection plate is located at an outermost part, each side of the first optical member is located inside the each side of the protection plate, and each side of the liquid crystal display panel is located inside the each side of the first optical member.

In addition to the above arrangement, in the liquid crystal display device of the present invention, the case includes at least two steps in its periphery, the each side of the protection plate is located on a plain surface of one of the steps, and the each side of the first optical member is located on a plain surface of other one of the steps.

In addition to the above arrangement, in the liquid crystal display device, the first optical member is provided on a back surface of the protection plate, and a deformation prevention film is provided on a front surface of the protection plate, the deformation prevention film having a same thermal shrinkage rate as the first optical member.

As described above, the liquid crystal display device of the present invention includes a first optical member provided on the protection plate, wherein optical conditions of the first optical member are set such that after passing through the protection plate and the first optical member, incident light from the observer side becomes elliptically polarized light, and is then incident on the liquid crystal layer. This can effectively reduce undesired reflection.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The invention is applicable to a mobile device or the like.

1. A liquid crystal display device which is operated in a circularly polarized light mode, comprising:
a liquid crystal display panel including a first substrate on an observer side, a second substrate on a backside, and a liquid crystal layer sandwiched between the first and second substrates; and
a protection plate which is provided on a front surface of the liquid crystal display panel via a space,
wherein the protection plate includes a first optical member whose optical conditions are set such that incident light from the observer side becomes elliptically polarized light after passing through the protection plate and the first optical member, the elliptically polarized light being incident on the liquid crystal layer.

2. The liquid crystal display device as set forth in claim 1, wherein the incident light has a wavelength of 550 nm and the elliptically polarized light has an ellipticity of not less than 0.4 but not more than 1.0.

3. The liquid crystal display device as set forth in claim 1, wherein the second substrate includes a reflective section provided on a side of the liquid crystal layer, which reflective section reflects the incident light from the observer side.

4. The liquid crystal display device as set forth in claim 1, wherein the second substrate includes a second optical member whose optical conditions are set such that incident light from a back surface opposite to the observer becomes elliptically polarized light after passing through the second optical member.

5. The liquid crystal display device as set forth in claim 4, wherein the elliptically polarized light has an ellipticity of not less than 0.4 but not more than 1.0.

6. The liquid crystal display device as set forth in claim 1, wherein the liquid crystal layer is made of a liquid crystal material having a negative permittivity anisotropy and
when no voltage is applied, the liquid crystal layer has a retardation of zero at least with respect to light having a wavelength of 550 nm so that a black display is carried out.

7. The liquid crystal display device as set forth in claim 3, wherein:
the liquid crystal layer is made of a liquid crystal material having a positive permittivity anisotropy,
the first optical member includes a first linear polarizing plate and a first wave plate, and
the first wave plate is set such that, when reaching the reflective section, the elliptically polarized light, which is incident on the liquid crystal layer, becomes nearly circularly polarized light at least with respect to light having a wavelength of 550 nm when a voltage is applied.

8. The liquid crystal display device as set forth in claim 1, wherein:
the first optical member includes a first linear polarizing plate and a first wave plate,
the first wave plate has, in its in-plane direction, a retardation of not less than 68 nm and not more than 208 nm with respect to light having a wavelength of 550 nm, and
the liquid crystal layer is made of a liquid crystal material having a positive permittivity anisotropy so that a white display is carried out when a voltage is applied.

9. The liquid crystal display device as set forth in claim 1, wherein an antistatic treatment is performed for each surface, facing the space, of the protection plate and the first substrate.

10. The liquid crystal display device as set forth in claim 1, wherein:
the protection plate includes a light-shielding region in its periphery, and
each side of the first optical member is located within the light-shielding region.

11. The liquid crystal display device as set forth in claim 1, further comprising:
a case for holding the protection plate, the first optical member, and the liquid crystal display panel such that, when the liquid crystal display device is viewed from the observer side, each side of the protection plate is located at an outermost part, each side of the first optical member is located inside of the each side of the protection plate, and each side of the liquid crystal display panel is located inside the each side of the first optical member.

12. The liquid crystal display device as set forth in claim 11, wherein:
the case includes at least two steps in its periphery,
the each side of the protection plate is located on a plain surface of one of the steps, and
the each side of the first optical member is located on a plain surface of other one of the steps.

13. The liquid crystal display device as set forth in claim 1, wherein:
the first optical member is provided on a back surface of the protection plate, and
a deformation prevention film is provided on a front surface of the protection plate, the deformation prevention film having a same thermal shrinkage rate as the first optical member.
